(19) United States
(12) Patent Application Publication
(10) Pub. No.: US 2018/0349673 A1
(43) Pub. Date: Dec. 6, 2018

(54) FINGERPRINT IDENTIFICATION MODULE

(71) Applicant: Gingy Technology Inc., Hsinchu City (TW)

(72) Inventors: Patrick Lin, Hsinchu City (TW); Jen-Chieh Wu, Hsinchu City (TW)

(73) Assignee: Gingy Technology Inc., Hsinchu City (TW)

(21) Appl. No.: 16/004,459

(22) Filed: Jun. 11, 2018

Related U.S. Application Data
(63) Continuation-in-part of application No. 15/239,842, filed on Aug. 18, 2016, now Pat. No. 10,049,256.
(60) Provisional application No. 62/266,002, filed on Dec. 11, 2015.
(60) Provisional application No. 62/620,985, filed on Jan. 23, 2018.

(30) Foreign Application Priority Data
Jul. 18, 2016 (TW) 105122567
Apr. 24, 2018 (CN) 201820588432.2

(51) Int. Cl. G06K 9/00; G02B 5/20; G06K 9/20

(52) U.S. Cl. CPC G06K 9/00046; G06K 9/0004; G06K 9/209; G06K 9/2027; G02B 5/20

(57) ABSTRACT

A fingerprint identification module including an image sensor, a light guide, at least one light source, a spatial filter and a reflector is provided. The light guide is disposed on the image sensor. The at least one light source is disposed beside the light guide and is configured to emit a light beam. The spatial filter is disposed between the light guide and the image sensor and has a plurality of light channels. The reflector is disposed between the light guide and the spatial filter, wherein the reflector has a plurality of light transmitting portions, and each of the light channels of the spatial filter overlaps the at least one light transmitting portion. The light beam is sequentially diffused by a fingerprint and passes through the light guide, the at least one light transmitting portion of the reflector, and each of the light channels of the spatial filter to be transmitted to the image sensor.

### CROSS-REFERENCE TO RELATED APPLICATION

This application is a continuation-in-part application of and claims the priority benefit of U.S. application Ser. No. 15/239,842, filed on Aug. 18, 2016, now pending, which claims the priority benefits of U.S. provisional application serial no. 62/266,002, filed on Dec. 11, 2015, and Taiwan application serial no. 105122567, filed on Jul. 18, 2016. This application also claims the priority benefits of U.S. provisional application Ser. No. 62/620,985, filed on Jan. 23, 2018, and China application serial no. 201820588432.2, filed on Apr. 24, 2018. The entirety of each of the above-mentioned patent applications is hereby incorporated by reference herein and made a part of this specification.

### BACKGROUND OF THE DISCLOSURE

### 1. Field of the Disclosure

The disclosure relates to an optical module and, more particularly, to a fingerprint identification module.

### 2. Description of Related Art

In recent years, fingerprint identification technology has been widely used in various electronic products such as a tablet computer, a smartphone, and the like to protect a user's privacy and tighten security on these products. Among the current fingerprint identification modules, before reaching an image sensor, a light beam which is diffused by a fingerprint needs to pass through multiple film layers such as a microstructure layer and a collimator to allow the light beam to be normally incident on the image sensor. As a result, information on clear fingerprints is obtained. However, the multiple film layers lead to difficulty in assembling the fingerprint identification module.

In terms of how to address the difficulty in assembling the fingerprint identification module, a plurality of light channels of the collimator may be formed by a plurality of light shielding layers and a plurality of light transmitting layers stacking on each other alternately. Each of the light channels corresponds to a pixel area of the image sensor and extends in an oblique direction. Each of the light beams diffused by all parts of the fingerprint may enter a correct pixel area through the light channel extending in the oblique direction, and cross-talk hardly occurs. The collimator having the light channel in the oblique direction may substitute for a combination of the microstructure layer and the collimator of the fingerprint identification module described above, so the microstructure layer is needless, and the difficulty in assembling the fingerprint identification module is reduced.

However, the fingerprint identification module still has the problem of uneven distribution of the light beam entering the image sensor. In other words, as the distance between the light beam, all parts of the fingerprint and a light source becomes longer, the intensity of the light beam radiating to all parts of the fingerprint becomes lower gradually to make the image sensor sense light beams that are distributed unevenly and to lower the quality of the fingerprint's captured images.

### SUMMARY OF THE DISCLOSURE

The disclosure provides a fingerprint identification module with ability to capture images of better quality.

The fingerprint identification module according to the disclosure is configured to sense a fingerprint of a finger. The fingerprint identification module includes an image sensor, a light guide, at least one light source, a spatial filter and a reflector. The light guide is disposed on the image sensor. The at least one light source is disposed beside the light guide and is configured to emit a light beam. The spatial filter is disposed between the light guide and the image sensor and has a plurality of light channels. The reflector is disposed between the light guide and the spatial filter and has a plurality of light transmitting portions, and each of the light channels of the spatial filter overlaps the at least one light transmitting portion of the reflector. The light beam is sequentially diffused by the fingerprint of the finger and passes through the light guide, the at least one light transmitting portion of the reflector and each of the light channels of the spatial filter to be transmitted to the image sensor.

According to an embodiment of the disclosure, the spatial filter further has a light blocking portion disposed between the two adjacent light channels. The reflector has at least one reflective portion that is disposed on the light blocking portion of the spatial filter.

According to an embodiment of the disclosure, the light transmitting portions of the reflector are a plurality of apertures of a reflective layer which overlap the plurality of light channels of the spatial filter, respectively.

According to an embodiment of the disclosure, the reflector is a reflective diffractive element.

According to an embodiment of the disclosure, the light channels of the spatial filter are arranged in a direction, each of the light channels has a width W1 in the direction, each of the light transmitting portions of the reflective diffractive element has a width W3 in the direction, and W3≤W1.

According to an embodiment of the disclosure, each of the light transmitting portions of the reflective diffractive element has a width W3 in the direction, the light beam has a wavelength λ, and 0.01λ≤W3≤100 λ.

According to an embodiment of the disclosure, the reflective diffractive element includes a light transmitting film and a reflective pattern layer which is disposed on the light transmitting film.

According to an embodiment of the disclosure, the fingerprint identification module includes a first adhesive layer which is disposed between the light guide plate and the reflector.

According to an embodiment of the disclosure, the fingerprint identification module includes a second adhesive layer which is disposed between the spatial filter and the image sensor.

According to an embodiment of the disclosure, the light guide has an upper surface, a lower surface relative to the upper surface and a side surface connected between the upper surface and the lower surface, each of the light channels extends in an oblique direction, an angle θ is between the oblique direction and a normal direction of the upper surface of the light guide, and 0°<θ<90°.

According to an embodiment of the disclosure, a cover plate is disposed on the light guide and has a pressing surface for the finger to press.

In view of the foregoing, the fingerprint identification module according to the embodiment of the disclosure includes the reflective portion of the reflector on the light blocking portion of the spatial filter. The light beam is distributed evenly in the light guide through the reflection of the reflective portion of the reflector to radiate to all parts of the fingerprint evenly. In this case, all parts of the fingerprint may diffuse the light beam of rather consistent intensity. As a result, the image sensor receives the sensed light beam having clear fingerprint information, and the quality of the fingerprint's captured images improves.

In order to make the aforementioned and other features and advantages of the disclosure comprehensible, several exemplary embodiments accompanied with figures are described in detail below.

### BRIEF DESCRIPTION OF THE DRAWINGS

The accompanying drawings are included to provide a further understanding of the disclosure, and are incorporated in and constitute a part of this specification. The drawings illustrate embodiments of the disclosure and, together with the description, serve to explain the principles of the disclosure.

FIG. 1 is a cross-sectional view of a fingerprint identification module according to an embodiment of the disclosure.

FIG. 2 is a top view of a reflector and a spatial filter of the fingerprint identification module of FIG. 1.

FIG. 3 is a cross-sectional view of a fingerprint identification module according to another embodiment of the disclosure.

FIG. 4 is a top view of the reflector and the spatial filter of the fingerprint identification module of FIG. 3.

FIG. 5 is a top view of a reflector and a spatial filter of a fingerprint identification module according to yet another embodiment of the disclosure.

FIG. 6 is a cross-sectional view of a fingerprint identification module according to another embodiment of the disclosure

### DESCRIPTION OF THE EMBODIMENTS

Reference will now be made in detail to the present preferred embodiments of the disclosure, examples of which are illustrated in the accompanying drawings. Wherever possible, the same reference numbers are used in the drawings and the description to refer to the same or like parts.

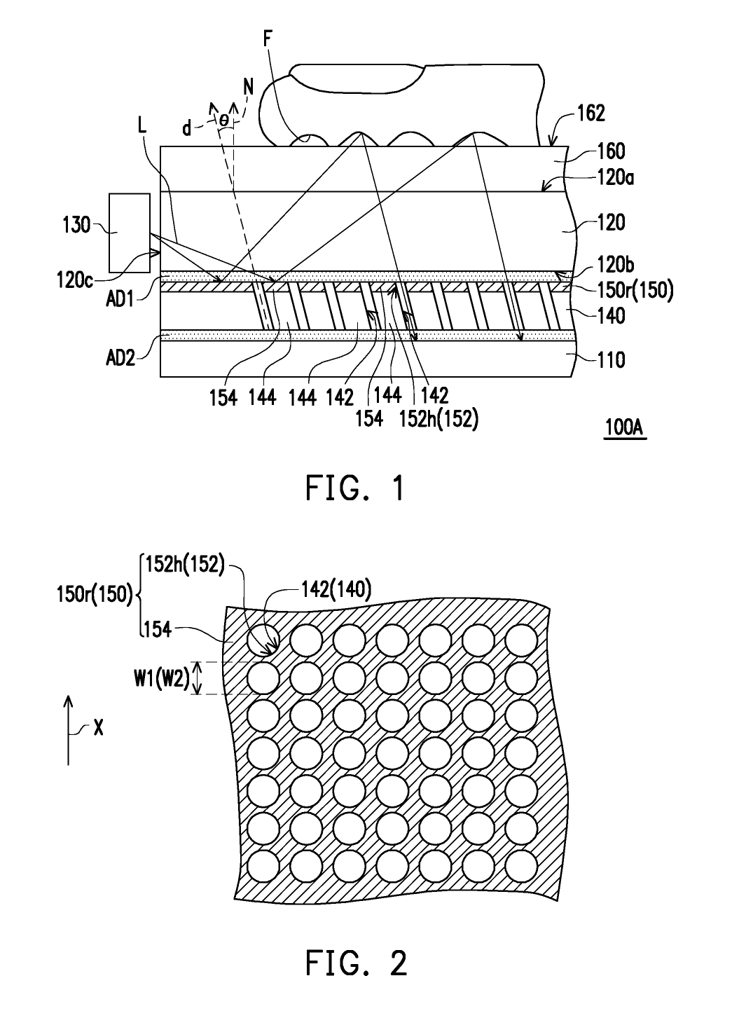

FIG. 1 is a cross-sectional view of a fingerprint identification module according to one embodiment of the disclosure. FIG. 2 is a top view of a reflector and a spatial filter of the fingerprint identification module of FIG. 1. Referring to FIG. 1, a fingerprint identification module 100A is configured to sense a fingerprint (or a palm print) F of a finger (or palm) and includes an image sensor 110, a light guide 120, at least one light source 130, a spatial filter 140 and a reflector 150. The light guide 120 is disposed on the image sensor 110. The at least one light source 130 is disposed beside the light guide 120 and is configured to emit a light beam L. In the embodiment, the image sensor 110 may be a photoelectric sensor, such as a charge-coupled device (CCD) or complementary-metal-oxide-semiconductor (CMOS) sensor, but the disclosure is not limited thereto. The light guide 120 may be a glass substrate, a plastic substrate or combinations thereof, but the disclosure is not limited thereto. The at least one light source 130 may be, for example, a light-emitting diode (LED), but the disclosure is not limited thereto. The light beam L emitted by the at least one light source 130 may be a visible light beam, an infrared beam or combinations thereof, but the disclosure is not limited thereto.

The spatial filter 140 is disposed between the light guide 120 and the image sensor 110 and has a plurality of light channels 142 and a light blocking portion 144 disposed between the two adjacent light channels 142. In the embodiment, for example, each of the light channels 142 and the light blocking portions 144 of the spatial filter 140 may be formed by a plurality of light transmitting layers (not shown) and light shielding layers (not shown) stacking on each other not in a straight line along an oblique direction d. The plurality of light transmitting layers and light shielding layers and workable stacking methods may be seen in Taiwanese Patent Application No. 107202731. In another embodiment, the light channels 142 and the light blocking portions 144 of the spatial filter 140 may be formed by a single light shielding layer having through holes, wherein the through holes of the single light shielding layer are the light channels 142 of the spatial filter 140, and a material part of the single light shielding layer is the light blocking portions 144 of the spatial filter 140. The light guide has an upper surface 120a, a lower surface 120b relative to the upper surface 120a and a side surface 120c connected between the upper surface 120a and the lower surface 120b. Each of the light channels 142 extends in the oblique direction d, an angle θ is between the oblique direction d and a normal direction N of the upper surface 120a of the light guide 120, and 0°<θ<90°. For example, in the embodiment, the angle θ between 30° and 85° is more preferable. Specifically, in the embodiment, the angle θ may be equal to 42°, but the disclosure is not limited thereto.

The reflector 150 is disposed between the lower surface 120b of the light guide 120 and the spatial filter 140 and has a plurality of light transmitting portions 152 and at least one reflective portion 154. Each of the light channels 142 of the spatial filter 140 overlaps the at least one light transmitting portion 152 of the reflector 150, and the at least reflective portion 154 of the reflector 150 is disposed on the light blocking portion 144 of the spatial filter 140. The light beam L emitted by the light source 130 is transmitted to a fingerprint F of the finger before being sequentially diffused by the fingerprint F of the finger and passing through the light guide 120, the light transmitting portion 152 of the reflector 150 and the light channel 142 of the spatial filter 140 to be transmitted to the image sensor 110. In the embodiment, the light transmitting portions 152 of the reflector 150 may be a plurality of apertures 152h of a reflective layer 150r which overlap the plurality of light channels 142 of the spatial filter 140, respectively.

Referring to FIGS. 1 and 2, the plurality of light channels 142 of the spatial filter 140 are arranged on the image sensor 110, and each of the light channels 142 corresponds to each pixel area (not shown) of the image sensor 110. The light blocking portion 144 is distributed between the plurality of light channels 142, and the reflective portion 154 of the reflector 150 is disposed on the light blocking portion 144. Each of the light channels 142 has a width W1 in a direction X (shown in FIG. 2), and the direction X is perpendicular to the normal direction N of the upper surface 120a of the light guide 120. Each of the light transmitting portions 152 (the apertures 152h) of the reflector 150 (the reflective layer 152r) has a width W2 in the direction X. In the embodiment, W1=W2, but the disclosure is not limited thereto. In another embodiment, it may be that W1<W2 or W1>W2.

It should be appreciated that the light beam L emitted by the light source 130 may be led to each position of the light guide 120 by the at least one reflective portion 154 disposed on the light blocking portion 144. As a result, the light beam L may be distributed evenly in the light guide 120, and there is little likelihood that the intensity of light is higher in an area of the light guide 120 near the light source 130, while the intensity of light is lower in an area of the light guide 120 that is away from the light source 130. In this case, the light beam L emitted from the upper surface 120a of the light guide 120 may radiate to the fingerprint F of the finger evenly, and the quality of capturing images by the image sensor 110 improves. Additionally, due to the presence of the spatial filter 140 that is disposed in the oblique direction and the reflector 150 according to the disclosure, the fingerprint identification module 100A does not require a plurality of film layers to rectify the moving direction of a light beam as the fingerprint identification module of prior art does. As a result, the fingerprint identification module 100A further has an advantage of being easy to assemble.

In the embodiment, the fingerprint identification module 100A further includes a first adhesive layer AD1 which is disposed between the light guide 120 and the reflector 150 and a second adhesive layer AD2 which is disposed between the spatial filter 140 and the image sensor 110. In the embodiment, the light guide 120 is bonded to the reflector 150 via the first adhesive layer AD1, and the spatial filter 140 is bonded to the image sensor 110 via the second adhesive layer AD2. The first adhesive layer AD1 and the second adhesive layer AD2 are made of, for example, an optical clear adhesive (OCA) of high transmittance, but the disclosure is not limited thereto. In another embodiment, the first adhesive layer AD1 and the second adhesive layer AD2 are made of other suitable materials, and/or the first adhesive layer AD1 and the second adhesive layer AD2 may also be made of different materials.

In the embodiment, the fingerprint identification module 100A further includes a cover plate 160 which is disposed on the upper surface 120a of the light guide 120 and has a pressing surface 162 for a finger to press. In the embodiment, the fingerprint F of the finger is placed on the pressing surface 162 of the cover plate 160, and the light source 130 emits the light beam L which is sequentially reflected by the reflector 150 and passes through the light guide 120 and the pressing surface 162 of the cover plate 160 to reach the position of the fingerprint F of the finger.

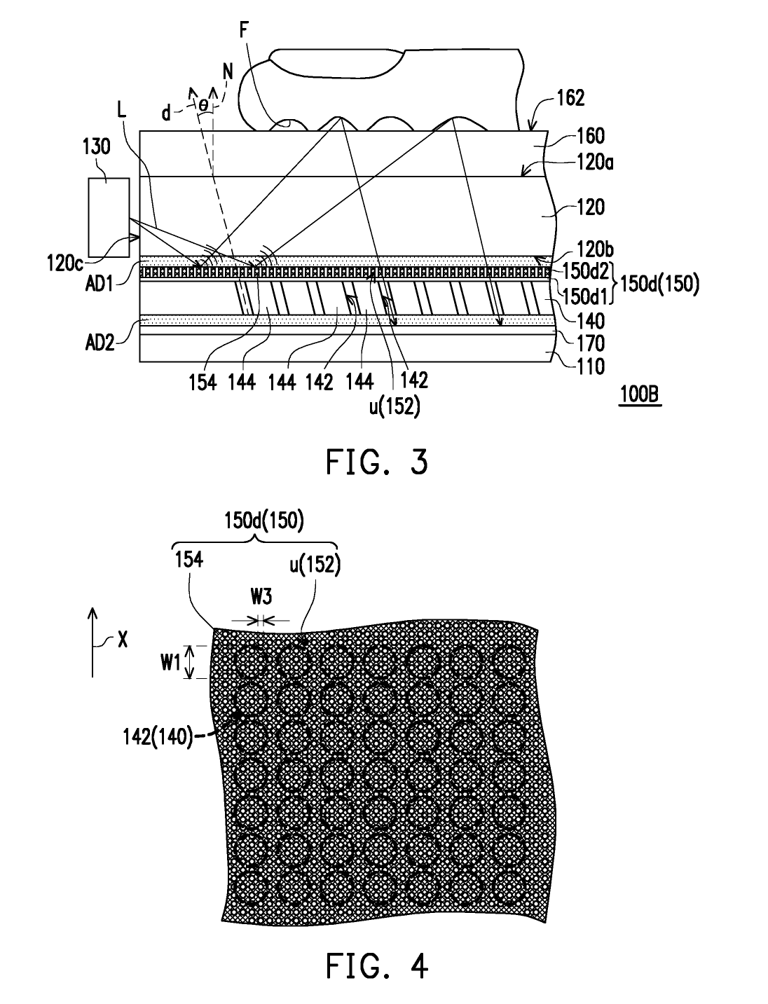

FIG. 3 is a cross-sectional view of a fingerprint identification module according to another embodiment of the disclosure. FIG. 4 is a top view of a reflector and a spatial filter of the fingerprint identification module of FIG. 3. Referring to FIG. 3, a fingerprint identification module 100B is similar to the fingerprint identification module 100A. Identical or similar parts of the fingerprint identification module 100B and the fingerprint identification module 100A are discussed above, and repeated descriptions are omitted accordingly. The main difference between the fingerprint identification module 100B and the fingerprint identification module 100A is that the reflector 150 in fingerprint identification module 100B is a reflective diffractive element 150d which may include a light transmitting film 150d1 and a reflective pattern layer 150d2 disposed on the light transmitting film 150d1. In the embodiment, the light transmitting film 150d1 may be disposed between the reflective pattern layer 150d2 and the spatial filter 140, but the disclosure is not limited thereto. In another embodiment, the light transmitting film 150d1 may also be disposed between the light guide 120 and the reflective pattern layer 150d2.

In the embodiment, the light channel 142 of the spatial filter 140 is arranged in the direction X, each of the light channels 142 has the width W1 in the direction X, each of the light transmitting portions 152 of the reflective diffractive element 150d has a width W3 in the direction X, and W3≤W1. For example, the light beam L has a wavelength λ, and (0.01)λ≤W3≤(100)λ. In other words, the size of the light transmitting portion 152 of the reflective diffractive element 150d is comparable to the wavelength of the light beam L, and the light beam L diffracts when passing through the light transmitting portion 152 of the reflective diffractive element 150d.

Referring to FIGS. 3 and 4, in the embodiment, the plurality of light transmitting portions 152 of the reflective diffractive element 150d may be a plurality of tiny apertures u. W3, the width of the light transmitting portion 152, is equal to a diameter of the tiny aperture u. The tiny apertures u overlap the light channels 142 of the spatial filter 140 and the light blocking portions 144 of the spatial filter 140, but the disclosure is not limited thereto. In another embodiment, the light transmitting portion 152 of the reflective diffractive element 150d may also be a slit structure having the width W3 similar to the wavelength λ of the light beam L. The slit structure is not limited to only have a single width W3 and nor are the plurality of slit structures limited to be disposed in parallel to each other. The plurality of slit structures may have different widths and be disposed parallel to each other or alternately.

In the embodiment, the light beam L diffracts on a surface of the reflective diffractive element 150d and is transmitted to the fingerprint F of the finger in a way of reflective diffraction. The fingerprint identification module 110B has similar effects and advantages to the aforementioned fingerprint identification module 100A, but repeated descriptions are omitted.

Moreover, the fingerprint identification module 100B further includes a bandpass filter 170 disposed between the image sensor 110 and the spatial filter 140. The light beam L can pass through the bandpass filter 170, and the bandpass filter 170 can cut off an environment light. However, the disclosure is not limited thereto, in another embodiment of the fingerprint identification module 100C of FIG. 6, the bandpass filter 170 may be disposed between the reflector 150 and the spatial filter 140.

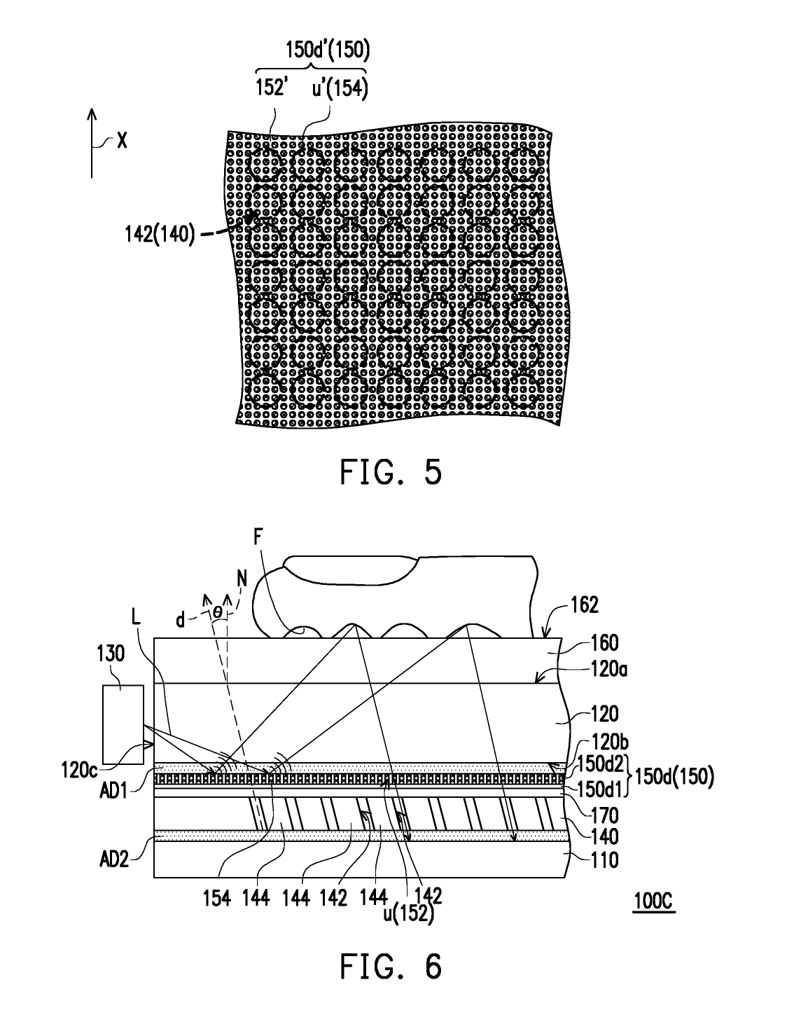

FIG. 5 is a top view of a reflector and a spatial filter of a fingerprint identification module according to yet another embodiment of the disclosure. Referring to FIGS. 4 and 5, the difference between a reflective diffractive element 150d′ of FIG. 5 and the reflective diffractive element 150d of FIG. 4 is that the reflective portions 154 of the reflective diffractive element 150d′ of FIG. 5 are a plurality of reflective tiny points u′, and light transmitting portions 152′ of the reflective diffractive element 150d′ of FIG. 5 are light transmitting areas among the plurality of reflective tiny points u′. The reflective diffractive element 150d′ of FIG. 5 has identical or similar functions to the reflective diffractive element 150d of FIG. 4. The reflective diffractive element 150d′ of FIG. 5 may be configured to substitute for the reflective diffractive element 150d of FIG. 3. The fingerprint identification module formed in this way is also protected by the disclosure.

In view of the foregoing, the fingerprint identification module according to the embodiment of the disclosure has the spatial filter which is disposed in the oblique direction and the reflector which is disposed on the spatial filter. The spatial filter has the plurality of light channels that are disposed in the oblique direction, and the reflective portion of the reflector is disposed between the adjacent light channels. In this case, the light beam may be reflected evenly by the reflector to enhance the quality of capturing images by the image sensor. Additionally, since the structure of a film layer with particular design is absent, the fingerprint identification module according to the disclosure is also easier to assemble than prior art. As a result, the difficulty of assembling the fingerprint identification module is reduced.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims and their equivalents.

What is claimed is:

1. A fingerprint identification module for sensing a fingerprint of a finger, the fingerprint identification module comprising:
an image sensor;
a light guide, disposed on the image sensor;
at least one light source, disposed beside the light guide and configured to emit a light beam;
a spatial filter, disposed between the light guide and the image sensor and having a plurality of light channels; and
a reflector, disposed between the light guide and the spatial filter, wherein the reflector has a plurality of light transmitting portions, and each of the light channels of the spatial filter overlaps the at least one transmitting portion of the reflector,
wherein the light beam is sequentially diffused by the fingerprint of the finger and passes through the light guide, the at least one light transmitting portion of the reflector and each of the light channels of the spatial filter to be transmitted to the image sensor.

2. The fingerprint identification module according to claim 1, wherein the spatial filter further has a light blocking portion disposed between the two adjacent light channels, and the reflector has at least one reflective portion disposed on the light blocking portion of the spatial filter.

3. The fingerprint identification module according to claim 1, wherein the light transmitting portions of the reflector are a plurality of apertures of a reflective layer which overlap the plurality of light channels of the spatial filter respectively.

4. The fingerprint identification module according to claim 1, wherein the reflector is a reflective diffractive element.

5. The fingerprint identification module according to claim 4, wherein the light channels of the spatial filter are arranged in a direction, each of the light channels has a width W1 in the direction, each of the light transmitting portions of the reflective diffractive element has a width W3 in the direction, and W3≤W1.

6. The fingerprint identification module according to claim 4, wherein each of the light transmitting portions of the reflective diffractive element has a width W3 in the direction, the light beam has a wavelength λ, and 0.01λ≤W3≤100λ.

7. The fingerprint identification module according to claim 4, wherein the reflective diffractive element comprises:
a light transmitting film; and
a reflective pattern layer, disposed on the light transmitting film.

8. The fingerprint identification module according to claim 1, further comprising:
a first adhesive layer, disposed between the light guide and the reflector.

9. The fingerprint identification module according to claim 1, further comprising:
a second adhesive layer, disposed between the spatial filter and the image sensor.

10. The fingerprint identification module according to claim 1, wherein the light guide has an upper surface, a lower surface relative to the upper surface and a side surface connected between the upper surface and the lower surface, each of the light channels extends in an oblique direction, an angle θ is between the oblique direction and a normal direction of the upper surface of the light guide, and 0°<θ<90°.

11. The fingerprint identification module according to claim 1, further comprising:
a cover plate, disposed on the light guide and having a pressing surface for the finger to press.

12. The fingerprint identification module according to claim 4, wherein the light guide has an upper surface, a lower surface relative to the upper surface and a side surface connected between the upper surface and the lower surface, each of the light channels extends in an oblique direction, an angle θ is between the oblique direction and a normal direction of the upper surface of the light guide, and 0°<θ<90°.

13. The fingerprint identification module according to claim 4, further comprising:
a cover plate, disposed on the light guide and having a pressing surface for the finger to press.

14. The fingerprint identification module according to claim 6, wherein the light guide has an upper surface, a lower surface relative to the upper surface and a side surface connected between the upper surface and the lower surface, each of the light channels extends in an oblique direction, an angle θ is between the oblique direction and a normal direction of the upper surface of the light guide, and 0°<θ<90°.

15. The fingerprint identification module according to claim 7, wherein the light guide has an upper surface, a lower surface relative to the upper surface and a side surface connected between the upper surface and the lower surface, each of the light channels extends in an oblique direction, an angle θ is between the oblique direction and a normal direction of the upper surface of the light guide, and 0°<θ<90°.

16. The fingerprint identification module according to claim 7, further comprising:
a bandpass filter, disposed between the image sensor and the spatial filter.

17. The fingerprint identification module according to claim 1, further comprising:
a bandpass filter, disposed between the spatial filter and the reflector.

18. The fingerprint identification module according to claim 16, wherein the light guide has an upper surface, a lower surface relative to the upper surface and a side surface connected between the upper surface and the lower surface, each of the light channels extends in an oblique direction, an angle θ is between the oblique direction and a normal direction of the upper surface of the light guide, and 0°<θ<90°.

19. The fingerprint identification module according to claim 17 wherein the light guide has an upper surface, a lower surface relative to the upper surface and a side surface connected between the upper surface and the lower surface, each of the light channels extends in an oblique direction, an angle θ is between the oblique direction and a normal direction of the upper surface of the light guide, and 0°<θ<90°.
